(19) United States
(12) Patent Application Publication
(10) Pub. No.: US 2023/0110279 A1
(43) Pub. Date: Apr. 13, 2023

(54) Fiber Material for Antibacterial and/or Antiviral Use, Filter, Mouth/Nose Protector, Insert for a Mouth/Nose Protector, and Methods for Producing a Fiber Material

(71) Applicant: Siemens Aktiengesellschaft, München (DE)

(72) Inventors: Jens Dahl Jensen, Berlin (DE); Ursus Krüger, Berlin (DE); Gabriele Winkler, Berlin (DE)

(73) Assignee: Siemens Aktiengesellschaft, München (DE)

(21) Appl. No.: 17/913,693

(22) PCT Filed: Mar. 8, 2021
(86) PCT No.: PCT/EP2021/055778

§ 371 Date: Sep. 22, 2022

(30) Foreign Application Priority Data
Mar. 24, 2020 (DE) 10 2020 203 783.3

(51) Int. Cl. D03D 15/258; A41D 13/11; A41D 31/30; D06M 11/48; D06M 11/50

(52) U.S. Cl. CPC D03D 15/258; A41D 13/1192; A41D 31/30; D06M 11/485; D06M 11/50

(57) ABSTRACT

Some embodiments of the teachings herein include a fiber material for antibacterial and/or antiviral use. The fiber material may comprise: a metallic silver; and manganese(IV) oxide.

### CROSS-REFERENCE TO RELATED APPLICATIONS

This application is a U.S. National Stage Application of International Application No. PCT/EP2021/055778 filed Mar. 8, 2021, which designates the United States of America, and claims priority to DE Application No. 10 2020 203 783.3 filed Mar. 24, 2020, the contents of which are hereby incorporated by reference in their entirety.

### TECHNICAL FIELD

The present disclosure relates to fiber materials. Various embodiments of the teachings herein may include fiber materials for antibacterial and/or antiviral use, filters, mouth/nose protectors, inserts for a mouth/nose protector, and/or methods for producing fiber materials for antibacterial and/or antiviral use.

### BACKGROUND

By way of example, fiber material can be used in antibacterial and/or antiviral filters or surgical mouth/nose protection masks. Furthermore, fiber material can be used in filters for respiratory protection devices or in air-conditioning systems exposed to changing ambient temperatures. These can often be wetted through during use, for example by atmospheric moisture or the moisture contained in respiratory air. This wetting-through is generally undesirable and can lead to spoilage and/or the need to change the filters.

### SUMMARY

The teachings of the present disclosure include fiber materials that, in the case of wetting-through, have an improved antibacterial and/or antiviral effect. For example, some embodiments of the teachings here include a fiber material for antibacterial and/or antiviral use comprising fibers having metallic silver and manganese(IV) oxide. This fiber material may be used for a gas-permeable filter and/or mouth/nose protector.

As an example, some embodiments include a fiber material (1) for antibacterial and/or antiviral use, comprising fibers having metallic silver and manganese(IV) oxide.

In some embodiments, the manganese(IV) oxide contacts the metallic silver at least in sections and the manganese(IV) oxide and the metallic silver are present as particles larger than 10 μm.

In some embodiments, the fiber material (1) has a surface composition: 10% to 25%, in particular 14% to 20%, of silver, 10% to 25%, in particular 16% to 19%, of manganese, and the manganese is in particular present as a manganese oxide, e.g. the manganese(IV) oxide.

In some embodiments, at least parts of the manganese(IV) oxide are arranged at least in sections between the fibers and the silver.

In some embodiments, the manganese(IV) oxide is arranged at least in sections on the silver.

In some embodiments, the fiber material (1) is configured as a nonwoven.

As another example, some embodiments include a filter, in particular a gas-permeable filter, having at least one filter layer (14) that has a fiber material (1) as described herein.

As another example, some embodiments include a mouth/nose protector (10), in particular a surgical mask, having a filter layer (14) that comprises a fiber material (1) as described herein.

In some embodiments, the filter layer (14) is arranged between an inner layer (16) and an outer layer (12).

In some embodiments, there is a water-repellent outer layer configured as a liquid-repellent nonwoven, and an inner layer (16) facing the mouth region of a wearer (100) of the mouth/nose protector (10) and configured as a skin-compatible polypropylene nonwoven.

As another example, some embodiments include an insert for use with a mouth/nose protector (10), having a filter layer (14) that comprises a fiber material (1) as described herein.

As another example, some embodiments include a respiratory protective mask having at least one filter as described herein.

As another example, some embodiments include a method for producing a fiber material (1), comprising: providing a raw fiber material (2), applying a first amount of manganese(II) nitrate or manganese(II) acetate and a first amount of potassium permanganate solution, to form manganese(IV) oxide on the raw fiber material (2), applying a solution comprising silver ions and a reducing agent to reduce the silver ions to form metallic silver, and applying a second amount of manganese(II) nitrate or manganese(II) acetate and a second amount of potassium permanganate solution, to form manganese(IV) oxide on the raw fiber material (2), wherein the second amount is greater than the first amount, in particular by a factor of 5.

As another example, some embodiments include a method for producing a fiber material (1) for antibacterial and/or antiviral use, comprising: providing a raw fiber material (2), applying a solution comprising silver ions to the raw fiber material (2), applying a reducing agent to reduce the silver ions to form metallic silver on the raw fiber material (2), applying a potassium permanganate solution to the raw fiber material (2), and applying manganese(II) nitrate or manganese(II) acetate, to form manganese(IV) oxide from the potassium permanganate solution on the raw fiber material (2).

As another example, some embodiments include a method for producing a fiber material (1) for antibacterial and/or antiviral use, comprising: providing an electrically conductive raw fiber material (2E), providing a direct current (DC), wherein the raw fiber material (2E) serves as cathode, applying a solution comprising silver ions to the raw fiber material (2E), in particular through a nozzle that has an anode made of a Ti/Pt wire or a Ti/Pt grid, electrochemically depositing metallic silver onto the raw fiber material (2E) from the solution, applying a potassium permanganate solution, and applying manganese(II) nitrate or manganese(II) acetate, to form manganese(IV) oxide from the potassium permanganate solution.

### BRIEF DESCRIPTION OF THE DRAWINGS

The teachings herein are described and explained in more detail in the text that follows on the basis of the exemplary embodiments illustrated in the figures. In the figures:

FIG. 1 shows a method for producing a fiber material incorporating teachings of the present disclosure;

FIG. 2 shows an alternative or additional method for producing a fiber material incorporating teachings of the present disclosure; and

FIG. 3 shows a mouth/nose protector having a fiber material incorporating teachings of the present disclosure as a filter.

### DETAILED DESCRIPTION

The teachings of the present disclosure make it possible to keep fiber materials and filters constructed therefrom very substantially free of microorganisms and viruses, even if said fiber materials and filters are wetted through. In the case of mouth/nose protection masks, wetting-through of the protection mask is an indication that it should be disposed of and replaced by a new one. This makes it possible to use even a wetted-through mask for significantly longer.

The silver and the manganese(IV) oxide can be applied to fibers very well, and form so-called oxygen radicals, also known as ROS (=reactive oxygen species), with the, actually undesired, moisture from the respiratory air or ambient air. These extremely reactive oxygen species can destroy proteins, lipids, RNA or DNA, of which bacteria and viruses consist, in such a way that a biochemical reaction occurs and bacteria and viruses are rendered harmless. This effect becomes stronger with increasing wetting-through and considerably improves the lifetime or the maximum permitted period of use of such a fiber material and of filters and masks having said fiber material.

By way of example, the fibers may be configured as pulp fibers, such as cellulose, plastics fibers, for example polypropylene, in particular microfibers made of polypropylene, ceramic fibers, or mixtures thereof and are advantageously provided as fiber material in webs on rolls.

In some embodiments, the manganese(IV) oxide contacts the metallic silver at least in sections. Furthermore, the manganese(IV) oxide and the metallic silver may be present as particles larger than 10 μm. Sizes of the resulting precipitate (i.e. the resulting particles or particle accumulations) of the silver and of the manganese oxide that are larger than 10 μm can be realized using spraying processes known from the prior art for applying solutions, such as those that may also be used for the methods described herein. Furthermore, the size of 10 μm ensures that the precipitate and the particles or particle accumulations thereof are consequently not nanoparticles. Furthermore, the resulting precipitate and the particles or particle accumulations thereof having a minimum size of 10 pm means that they are not respirable particles, this being essential especially when used in mouth/nose protection masks or respiratory air filters, even if the adhesion to the fiber material is very good.

In some embodiments, the fiber material has the following surface composition:
10% to 25%, in particular 14% to 20%, of silver,
10% to 25%, in particular 16% to 19%, of manganese, wherein the manganese is in particular present as a manganese oxide.

This surface composition can be determined by way of an EDX analysis (energy-dispersive X-ray spectroscopy) on a scanning electron microscope (SEM). The SEM EDX analysis is used to determine the elemental chemical composition for spatially resolved material analyses. This method can be used to analyze surface composition. In some embodiments, the surface composition furthermore has 10% to 25%, in particular 12% to 18%, of oxygen, wherein the oxygen may in particular be present together with the manganese as a manganese oxide. In other words, the surface composition is formed on the fiber material as a particle distribution (accumulations of particles/individual particles) of the metallic silver and of the manganese(IV) oxide, said particle distribution being deposited on the surface of the fiber material.

In some embodiments, at least parts of the manganese(IV) oxide are arranged at least in sections between the fibers and the silver. It has been found that the adhesion of the silver to the fibers can thus be considerably improved and at the same time the antimicrobially active compound can already be applied as adhesion promoter.

In some embodiments, the manganese(IV) oxide is arranged at least in sections on the silver. This can be realized by way of the methods described herein.

In some embodiments, the metallic silver, with respect to the manganese(IV) oxide, has a mass ratio of 200:1 to 10:1. It has emerged that with respect to the silver, only very small amounts of manganese oxide are necessary in order to achieve a significantly improved antiviral and antimicrobial effect.

In some embodiments, the manganese(IV) oxide has a mass fraction of 0.01 to 0.5 wt % with respect to the fibers. It has emerged that only a very small fraction of manganese dioxide is needed also with respect to the fibers.

In some embodiments, the metallic silver has a mass fraction of 0.1 to 5 wt % with respect to the fibers. In comparison to known substances coated with silver, the silver fraction can be kept particularly low, since the fraction of manganese dioxide leads to significantly increased reactivity.

In some embodiments, the fibers are at least partially coated with the metallic silver and the silver is doped with the manganese(IV) oxide.

In some embodiments, the fiber material is configured as a nonwoven. By way of example, spunbond nonwoven fabrics made of polypropylene are well suited in this case. Further plastics nonwovens are likewise well suited and can be coated well.

Some embodiments include a filter that has a filter layer having one or more of the fiber materials described herein. The filter may be configured to be gas-permeable and can have further filter layers. The filter layer made of the fiber material can thus be embedded in further filter layers, such as an activated carbon filter, and filter layers for filtering coarse dirt. In addition to the antibacterial and antiviral effect, the filter can thus be supplemented in a simple manner by further layers having further filter properties.

Some embodiments include a mouth/nose protector, in particular a surgical mask, having a layer that comprises a fiber material described herein. In other words, the mouth/nose protector comprises at least one fiber material incorporating teachings of the present disclosure. In some embodiments, the layer consists completely of the fiber material. The layer, that is to the say the fiber material, is arranged here such that the respiratory air from the wearer of the mask flows through the layer when said wearer breathes in and/or out. Significantly improved protection of the wearer from bacteria and viruses can thus be ensured even in the case of extreme periods of wear and accompanying great wetting-through/saturation of the mouth/nose protector with respiratory moisture. In addition, third parties can thus also be protected from bacteria and viruses emanating from the wearer, since these are already destroyed in the mask when said wearer breathes out.

In some embodiments, the mouth/nose protector has an inner layer and an outer layer. The filter layer is arranged here between the inner layer and the outer layer. The filter layer can thus be optimized for the optimal antiviral effect while the outer layer and inner layer can fulfill further functions.

In some embodiments, the mouth/nose protector has a water-repellent, for example hydrophobic, outer side through which the respiratory air can flow. The outer side may be configured as a liquid-repellent nonwoven, so that potentially infectious droplets do not even get through to the filter layer in the first place. It is likewise conceivable for the filter layer according to the invention to have an outer side with a hydrophobic coating. In some embodiments, the mouth/nose protector has an inner layer facing the mouth region of a wearer of the mouth/nose protector and may be configured as a skin-compatible nonwoven, for example a polypropylene nonwoven. This layer construction is particularly advantageous if the masks are manufactured on an industrial scale and are used in the professional sphere.

Since bacteria and viruses in the respiratory air are killed off, the antibacterially and antivirally active fiber mats made of the fiber material according to the invention can be used as respiratory protection mask or in a mouth/nose protector both for infected and non-infected persons. The relatively long protective effect makes it possible to avoid a shortage in hospitals and care facilities. The fiber mats may be used in all types of filter, for example in special air purification filters for portable respiratory protection devices in which the air purification filters must be replaced. Use in air-conditioning systems for filtering humid ambient air of buildings and vehicles is likewise conceivable. In the hospital sector, examination equipment and ventilation equipment can be improved through the use of the filters described herein.

Some embodiments include an insert for use with a conventional mouth/nose protector. The insert is configured such that it can be inserted into an existing mouth/nose protector or adhered thereto. The insert has a filter layer that has a fiber material according to the invention and that can be arranged such that it is possible to breathe in and/or out through the insert. The insert has the advantage that only the filter layer has to be manufactured and it is thus possible to equip existing and large amounts of masks therewith in a quick and simple manner.

Some embodiments include a respiratory protection mask having at least one filter incorporating teachings of the present disclosure. The filter or the filter layer can be integrated here into a respiratory protection filter. This filter can have further NBC protective functions.

Some embodiments include a method in which, on the provided raw fiber material, a first amount of manganese(II) nitrate or manganese(II) acetate and a first amount of potassium permanganate solution are applied to the raw fiber material, in order to form manganese(IV) oxide on the raw fiber material (2). It has been found that in particular polymer nonwovens, such as polypropylene or polyethylene, that have hydrophobic properties can be coated in a considerably improved manner in this way. It has emerged that the first, very small amount of manganese(IV) oxide considerably reduces the hydrophobic properties and thus enables better coating with silver. The adhesive strength of the resultant coating, that is to say the adhesion of the resulting precipitate to the fiber material, may likewise be considerably improved. The solutions used may be applied simultaneously, for example by way of appropriate nozzle systems.

In some embodiments, once the first amount of manganese(IV) oxide has been applied, it is possible to apply a solution comprising silver ions and a reducing agent to reduce the silver ions to form metallic silver on the raw fiber material. The reducing agent and the solution comprising silver ions may be applied simultaneously, for example by way of an appropriate nozzle system.

In particular, as a following step, a second amount of manganese(II) nitrate or manganese(II) acetate and a second amount of potassium permanganate solution are applied, to form manganese(IV) oxide, to the raw fiber material that is in particular already provided with silver. These second amounts are greater than the first amounts, in particular by a factor of 5 or more. The first amount serves to reduce the hydrophobicity and is in this case already part of the antimicrobially active precipitate.

Some embodiments include a method for producing a fiber material for antibacterial and/or antiviral use. This method comprises the following, which by way of example can be performed in the following sequence:
providing a raw fiber material,
applying a solution comprising silver ions to the raw fiber material,
applying a reducing agent to reduce the silver ions to form metallic silver on the raw fiber material (2),
applying a potassium permanganate solution to the raw fiber material, and
applying manganese(II) nitrate or manganese(II) acetate, each present for example in basic solution, to form manganese(IV) oxide from the potassium permanganate solution on the raw fiber material.

The solution comprising silver ions here may be a silver salt solution. This method may be performed on webs of the fiber material, for example by applying, in a production line, first the metallic silver and then the manganese(IV) oxide. The major advantage is that the webs can be sprayed at high speed by nozzles and therefore large amounts of the fiber material can be produced.

It has emerged that the method results in very good adhesion of the silver to the fiber material and in particular also of the manganese(IV) oxide to the fiber material. This is what makes it possible to use the present fiber material in respiratory air filters.

Some embodiments include a method for producing a fiber material for antibacterial and/or antiviral use, that can be performed as an alternative or in addition to the preceding method. The method comprises:
providing an electrically conductive raw fiber material,
providing a direct current, wherein the raw fiber material serves as cathode, that is to say is connected to the negative pole of a direct-current source,
applying a solution comprising silver ions to the raw fiber material, in particular through a nozzle that has an anode made of a Ti/Pt wire or a Ti/Pt grid, wherein this anode is connected to the positive pole of the direct-current source,
electrochemically depositing metallic silver onto the raw fiber material from the solution,
applying a potassium permanganate solution and
applying manganese(II) nitrate or manganese(II) acetate, each present for example in basic solution, to form manganese(IV) oxide from the potassium permanganate solution.

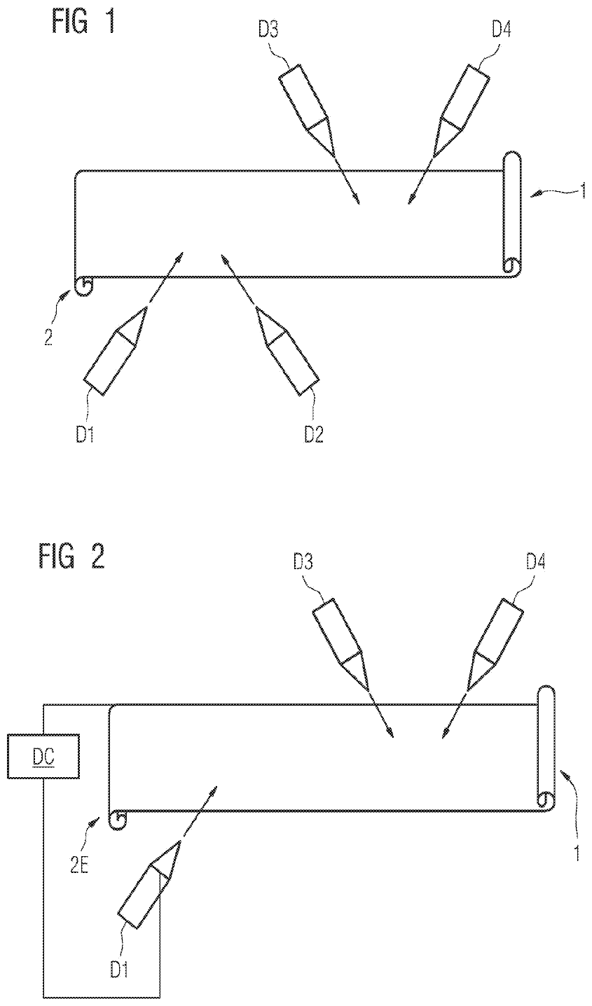

FIG. 1 is a schematic drawing showing a spray technique for producing a coated fiber material 1 that is rolled up on a roll on the right-hand side of FIG. 1. A first nozzle Dl is used to spray a water-soluble silver salt solution (for example silver nitrate or silver acetate) onto a raw fiber material 2 provided in webs from a schematically represented roll on the left-hand side of FIG. 1. A second nozzle D2 is used to spray a reducing agent (for example sodium hypophosphite or organic reducing agents such as aldoses, for example glucose) onto the raw fiber material 2, the reducing agent serving to reduce the silver ions to form metallic silver. The individual spraying processes of the nozzles D1, D2 here can act on the raw fiber material 2 simultaneously or successively, for example in predetermined cycle times.

Once the raw fiber material 2 has been sprayed with the silver salt solution and the reducing agent, manganese(IV) oxide—also known as manganese dioxide—is then deposited onto the raw fiber material 2 that is now provided with metallic silver. To this end, potassium permanganate solution is sprayed via a third nozzle D3 and manganese(II) nitrate or manganese(II) acetate is sprayed via a fourth nozzle D4, each in basic solution. Manganese dioxide is produced from Mn +7 and Mn +2 by way of a comproportionation (a special case of a redox reaction). The fiber mat can be heated by a suitable heat source so as to accelerate the chemical reaction. The resultant bonding of the fibers of the fiber material 1 to the silver and the manganese dioxide is very well suited for use of the fiber material 2 in respiratory air filters and mouth/nose protection masks.

FIG. 2 is a schematic drawing showing a nozzle Dl that has an electrode made of a Ti/Pt wire or of a Ti/Pt grid and is connected to a direct-current source DC. In this embodiment, the metallic silver is deposited from the electrolyte solution by way of an electrochemical spray process. To this end, it is necessary to provide a raw fiber material 2E that is electrically conductive. Electrically conductive fiber material 2E is available commercially for example in the form of fiber mats. In some embodiments, an electrically non-conductive raw fiber material 2 can be treated with special solutions that provide the electrically non-conductive raw fiber material 2 with an electrically conductive layer and therefore make the raw fiber material 2 electrically conductive. Particularly advantageous here are materials that are found in a living organism as trace element and are not toxic (for example Cu or Zn). The raw fiber material 2E here serves in particular as cathode, that is to say is connected to the negative pole of the direct-current source DC. The Ti/Pt wire or the Ti/Pt grid in the first nozzle Dl serves as anode, this anode in particular being connected to the positive pole of the direct-current source DC. Thus, as an alternative or in addition to FIG. 1, the silver can be deposited electrochemically. Very good bonding to the fibers can thus also be achieved.

Subsequently, as described for the spraying process in FIG. 1, manganese dioxide (manganese(IV) oxide) is applied from a potassium permanganate and manganese(II) salt solution by means of the nozzles D3 and D4.

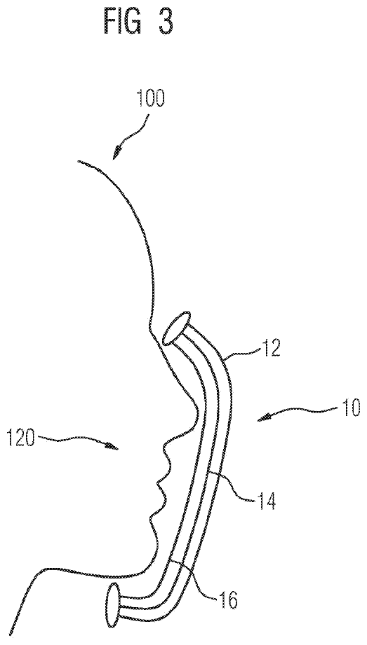

FIG. 3 is a schematic drawings showing a head of a person 100 having a mouth/nose region 120. This mouth/nose region 120 is covered by a mouth/nose protector 10. This mouth/nose protector 10 has three layers: an outer layer 12, an inner layer 16 and a filter layer 14 comprising a fiber material 1 coated in accordance with the present invention. These layers 12, 14, 16 may be welded at the edge so that good cohesion is produced. This mouth/nose protector 10 usually has a fastening means that for example can be fastened around the head of the person 100 or on the ears of the person 100. This resultant mouth/nose protector 10 can be worn for longer than a comparable mouth/nose protector from the prior art, since wetting-through by the respiratory air brings about an enhanced antiviral and antibacterial effect.

In summary, the present disclosure relates to fiber materials for antibacterial and/or antiviral use that, in the case of wetting-through, has an improved antibacterial and/or antiviral effect. Furthermore, the teachings relate to a filter, a mouth/nose protector, an insert for a mouth/nose protector, and methods for producing a fiber material for antibacterial and/or antiviral use.

What is claimed is:

1. A fiber material for antibacterial and/or antiviral use, the fiber material comprising:
metallic silver; and
manganese(IV) oxide.

2. The fiber material as claimed in claim 1, wherein:
the manganese(IV) oxide contacts the metallic silver at least in sections; and
the manganese(IV) oxide and the metallic silver are present as particles larger than 10 μm.

3. The fiber material as claimed in claim 1, wherein a surface composition comprises:
10% to 25% of silver; and
10% to 25% of manganese (IV) oxide.

4. The fiber material as claimed in claim 1, wherein at least parts of the manganese(IV) oxide are arranged at least in sections between the fibers and the silver.

5. The fiber material as claimed in claim 1, wherein the manganese(IV) oxide is arranged at least in sections on the silver.

6. The fiber material as claimed in claim 1, wherein the fiber material comprises a nonwoven.

7. (canceled)

8. A mouth/nose protector comprising:
a cover configured to fit over a mouth and/or nose of a wearer; and
a filter layer including a fiber material;
wherein the filter layer comprises:
metallic silver; and
manganese(IV) oxide.

9. The mouth/nose protector as claimed in claim 8, further comprising an inner layer and an outer layer;
wherein the filter layer is arranged between the inner layer and the outer layer.

10. The mouth/nose protector as claimed in claim 8, further comprising a water-repellent outer layer configured as a liquid-repellent nonwoven; and
an inner layer facing a mouth region of the wearer and configured as a skin-compatible polypropylene nonwoven.

11.-12. (canceled)

13. A method for producing a fiber material, the method comprising:
providing a raw fiber material;
applying a first amount of manganese(II) nitrate or manganese(II) acetate and a first amount of potassium permanganate solution to form manganese(IV) oxide on the raw fiber material;
applying a solution comprising silver ions and a reducing agent to reduce the silver ions to form metallic silver; and
applying a second amount of manganese(II) nitrate or manganese(II) acetate and a second amount of potassium permanganate solution to form manganese(IV) oxide on the raw fiber material;
wherein the second amount is greater than the first amount by a factor of at least 5.

14. A method for producing a fiber material for antibacterial and/or antiviral use, the method comprising:
providing a raw fiber material;
applying a solution comprising silver ions to the raw fiber material;
applying a reducing agent to reduce the silver ions to form metallic silver on the raw fiber material;
applying a potassium permanganate solution to the raw fiber material; and
applying manganese(II) nitrate or manganese(II) acetate to form manganese(IV) oxide from the potassium permanganate solution on the raw fiber material.

15. A method for producing a fiber material for antibacterial and/or antiviral use, the method comprising:
providing an electrically conductive raw fiber material;
applying a direct current to the raw fiber material, wherein the raw fiber material serves as a cathode;
applying a solution comprising silver ions to the raw fiber material through a nozzle that has an anode made of a Ti/Pt wire and/or a Ti/Pt grid;
electrochemically depositing metallic silver onto the raw fiber material from the solution;
applying a potassium permanganate solution; and
applying manganese(II) nitrate or manganese(II) acetate to form manganese(IV) oxide from the potassium permanganate solution.
